(19) United States
(12) Patent Application Publication
(10) Pub. No.: US 2008/0148100 A1
(43) Pub. Date: Jun. 19, 2008

(54) CONTROL PANEL ASSEMBLY METHOD FOR A FITNESS EQUIPMENT METER

(75) Inventors: Hsien-Lung Chou, Taichung City (TW); Hsien-Nan Chou, Taichung City (TW)

Correspondence Address: EGBERT LAW OFFICES, 412 MAIN STREET, 7TH FLOOR, HOUSTON, TX, 77002, US

(73) Assignee: KING I TECH CORPORATION, Taichung City (TW)

(21) Appl. No.: 11/549,955

(22) Filed: Oct. 16, 2006

(51) Int. Cl. G06F 11/00

(52) U.S. Cl. 714/30

(57) ABSTRACT

The present invention is a control panel assembly method for a fitness equipment meter. The processors of the A/D module and IC module are integrated into a single processor, namely, all control firmware and electric components of the control panel as well as the control program are combined into a single processor. The ECU of the IC module works with the integrated control mode to comprehensively control the motion and display functions of the control panel. Electric components are saved, reducing the manufacturing cost and efficiently shortening the communication time of processors for a markedly improved response and performance of an electric circuit.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an assembly method for a control panel of a fitness equipment meter, and more particularly for an innovative control panel which combines an A/D module and IC module into the processor.

2. Description of Related Art

Including Information Disclosed Under 37 CFR 1.97 and 37 CFR 1.98.

The control system of a fitness equipment meter generally comprises an IC board and an A/D board. During operation, the A/D board serves as a bridge between the IC board and display unit (LCD) such that information input from the IC board can be smoothly converted and then presented on the LCD screen with preset characters or patterns.

The control system of a typical fitness equipment meter is illustrated in FIG. 1. The IC board 10 and A/D board 20 are each separately equipped with a stand-alone processor 11, 21 (CPU or MCU). The information input from IC board 10 is transmitted to processor 11 of the IC board 10, then to the processor 21 of the A/D board 20, and finally to display unit 30.

The prior art has disadvantages in actual operation. The information must flow from processor 11 of the IC board 10 to processor 21 of the A/D board 20. The IC board 10 and A/D board 20 are made of different boards, such that the transmission of information is achieved by linking the boards by electric wire. Thus, it is difficult to improve transmission efficiency and product quality and to save electronic components.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

There is enhanced efficacy in the present invention. The innovation of the present invention is to integrate a processor 41 of an IC module 40 and a processor 51 of an A/D module 50 into a single processor 70. In such a case, it should be possible to save a processor and relevant electric components (e.g. oscillator modules), simplifying the manufacturing process for decreasing costs.

Since the processors 41, 51 of the IC module 40 and A/D module 50, respectively, are integrated into a single processor 70, it should be possible to efficiently decrease the communication time between processors and to considerably improve the response and performance of electric circuit.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of a control panel of a typical fitness equipment meter in the prior art.

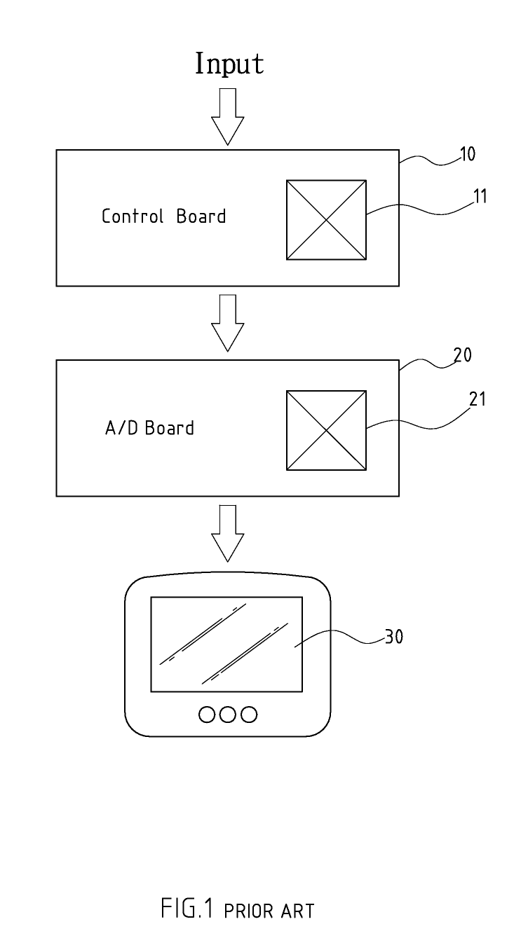

FIG. 2 shows a schematic view of the control panel of a fitness equipment meter of the present invention.

FIG. 3 shows another schematic view of the control panel of fitness equipment meter of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

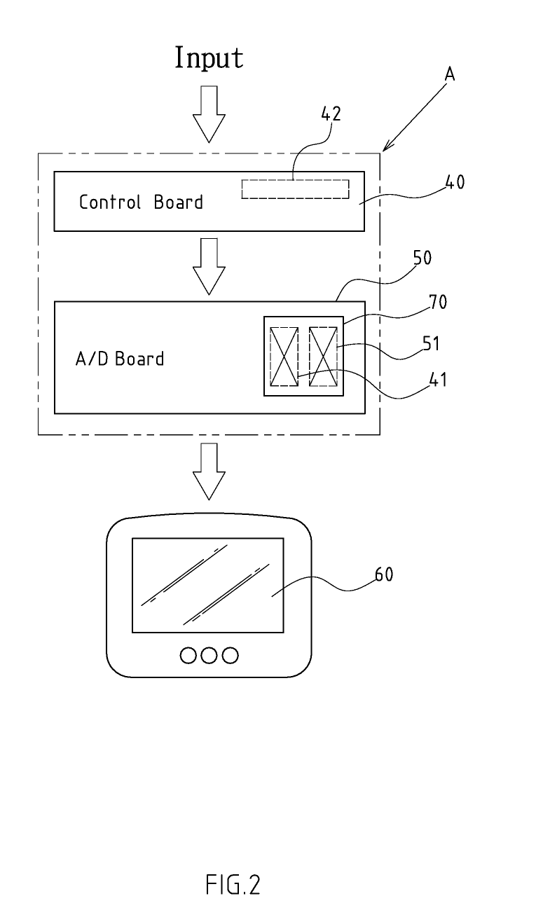

FIG. 2 depicts a preferred embodiment of the control panel assembly method for a fitness equipment meter of the present invention. The preferred embodiment is provided only for explanatory purposes. The scope of the invention is determined by the patent claims.

The control panel A comprises an IC module 40, an A/D module 50 (A/D Board) and two processors 41, 51 (CPU or MCU). The processors 41, 51 belong to IC module 40 and A/D module 50, respectively and separately. The A/D module 50 is connected to a preset display unit 60. The display unit 60 may be a TFT-LCD, CRT, OLED and PDP. The IC module 40 is equipped with an ECU 42, which comprises an input setting module (e.g. functional keys) and a motion detection module (e.g. heart beat and speed detection). The method of the present invention integrates processor 41 of IC module 40 and processor 51 of A/D module 50 into a single processor 70, controlling firmware and electric components of control panel A. The control program is combined into a single processor 70, such that ECU 42 of IC module 40 could work with the integrated control mode to comprehensively control the motion and display functions of control panel A.

A/D module 50 and IC module 40 can be separately mounted onto different electric substrates, such that the processor 70 may be assembled into either A/D module 50 or IC module 40. Referring to FIG. 2, the processor 70 is assembled into the electric substrate of A/D module 50.

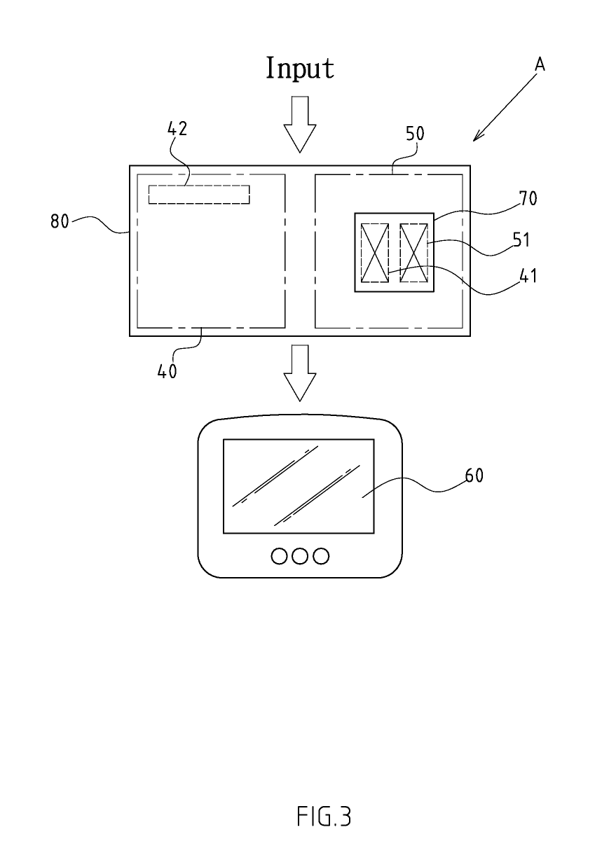

Referring also to FIG. 3, A/D module 50 and IC module 40 can be collectively mounted onto a single electric substrate 80.

In addition, the innovative integration of processor 41 of IC module 40 and processor 51 of A/D module 50 could save both a processor and relevant electric components. For example, processor 41, 51 (CPU or MCU) often reaches the expected frequency with the help of oscillator module (generally including oscillator and capacitor), so the integration of the present invention enables an oscillator module of processor (41 or 51) to be integrated into the same module interface (IC module 40 or A/D module 50), thus saving the oscillator modules for reducing the quantity of electric components. In contrast, the processors on an IC board and A/D board of a typical prior art control panel must be separately equipped with an oscillator module.

We claim:

1. A control panel assembly method for a fitness equipment meter, the assembly method comprising the steps of:
forming a control panel assembly by an A/D module, IC module and respective processors;
connecting said A/D module to a preset display unit; and
integrating processors of said A/D module and IC module into a single processor, wherein all control firmware, electric components of said control panel assembly, and a control program are combined into a single processor, said IC module having an ECU working with an integrated control mode to control motion and display functions of said control panel assembly.

2. The assembly method defined in claim 1, further comprising:
mounting said A/D module and IC module collectively onto a single electric substrate.

3. The assembly method defined in claim 1, further comprising:
mounting said A/D module and IC module separately onto different electric substrates, the processors being assembled onto said A/D module or IC module

4. The assembly method defined in claim 1, further comprising:
forming said preset display unit by a TFT-LCD, CRT, OLED and PDP.

5. The assembly method defined in claim 1, wherein said ECU of said IC module comprises an input setting module and motion detection module.
